(19) United States
(12) Patent Application Publication
(10) Pub. No.: US 2006/0064565 A1
(43) Pub. Date: Mar. 23, 2006

(54) Data processing in a distributed computing system

(76) Inventors: Andrew David James Banks, Hampshire (GB); Daniel Noel Millwood, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/228,763

(22) Filed: Sep. 16, 2005

(30) Foreign Application Priority Data
Sep. 18, 2004 (GB) 0420810.4

(51) Int. Cl. G06F 12/14

(52) U.S. Cl. 711/173

(57) ABSTRACT

A data processing system includes a plurality of message processing units and a directory communicating with at least one of the message processing units. A first system element identifier is transmitted to the directory. The first system element identifier includes a version indicator and a sequence indicator. The first system element identifier is received from the directory. A second system element identifier is transmitted. The second system element identifier includes a version indicator and a sequence indicator. The version for the second system element identifier is determined by a comparing the sequence indicator in the first system element identifier with an expected sequence indicator to determine what the version indicator for the second system element identifier should be.

### BACKGROUND OF THE INVENTION

This invention relates to data processing, and more particularly, to a client/server (also known as “distributed”) computing systems, where one computing device (“the client”) requests another computing device (“the server”) to perform part of the client's work.

Client/server computing has become more and more important over the past few years in the information technology world. This type of distributed computing allows one machine to delegate some of its work to another machine that might be, for example, better suited to perform that work. For example, the server could be a high-powered computer running a database program managing the storage of a vast amount of data, while the client is simply a desktop personal computer (PC) which requests information from the database to use in one of its local programs.

Message queuing data processing technology has become more and more prevalent in today's client/server computer networks. This technology permits a client computer system to communicate with a server computer system even though these two systems are very different to each other, in terms of operating system, data format and communication protocol. Further, due to the asynchronous nature of this technology the client can send the server a message and the server can store the message in a queue and process and respond to the message at a later time. This is quite different from the synchronous client/server models that have required the client and server to converse in real time (e.g. the client waits for the server to respond before the client carries on with other tasks). Message queuing and commercially available message queuing products are described in “Messaging and Queuing Using the MQI”, B. Blakeley, H. Harris & R. Lewis, McGraw-Hill, 1994.

In client/server data processing systems that use message engines, it is typical to have a directory service or directory, which is responsible for keeping a record of the current status of each messaging engine and any queues associated with that messaging engine. In normal operation, each messaging engine informs the directory service of resources using an identifier that includes a timestamp derived from the messaging engine's internal clock. This allows the directory service to keep track of which is the latest identifier (in relation to the status of the messaging engine), and also those resources that are currently in effect. However, in certain operating circumstances, this can lead to the directory service ignoring resources or regarding resources that should be considered current to be out of date. This will occur when the messaging engine's internal clock has been altered from its normal running.

### BRIEF SUMMARY OF THE INVENTION

According to one aspect of the present invention, a system for operation in a data processing system comprises a plurality of message processing units and a directory communicating with at least one of the message processing units. The system comprises a first transmitting component for transmitting to the directory a first system element identifier. The first system element identifier comprises a version indicator and a sequence indicator. The system further comprises a receiving component for receiving from the directory the first system element identifier and a second transmitting component for transmitting a second system element identifier. The second system element identifier comprises a version indicator and a sequence indicator with the version for the second system element identifier being determined by a versioning component. The versioning component is operable to compare the sequence indicator in the first system element identifier with an expected sequence indicator to determine what the version indicator for the second system element identifier should be.

According to another aspect of the present invention, a method for operation in a data processing system comprising a plurality of message processing units and a directory communicating with at least one of the message processing units comprises transmitting to the directory a first system element identifier, the first system element identifier comprising a version indicator and a sequence indicator, and receiving from the directory the first system element identifier, transmitting a second system element identifier, the second system element identifier comprising a version indicator and a sequence indicator. The version for the second system element identifier is determined by a comparing the sequence indicator in the first system element identifier with an expected sequence indicator to determine what the version indicator for the second system element identifier should be.

According to yet another aspect of the present invention, a computer program product for operation in a data processing system comprises a plurality of message processing units and a directory communicating with at least one of the message processing units. The computer program product comprises a computer usable medium having computer useable program code embodied therein. The computer useable program code comprises computer usable program code configured to transmit to the directory a first system element identifier, the first system element identifier comprising a version indicator and a sequence indicator, computer usable program code configured to receive from the directory the first system element identifier, and computer usable program code configured to transmit a second system element identifier, the second system element identifier comprising a version indicator and a sequence indicator. The version for the second system element identifier is determined by computer usable program code configured to compare the sequence indicator in the first system element identifier with an expected sequence indicator to determine what the version indicator for the second system element identifier should be.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a schematic view of a data processing system including message processing units and a directory,

FIGS. 2 and 3 are flow diagrams of data processing methods,

FIG. 4 is a further schematic view of the data processing system of FIG. 1.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-usable or computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

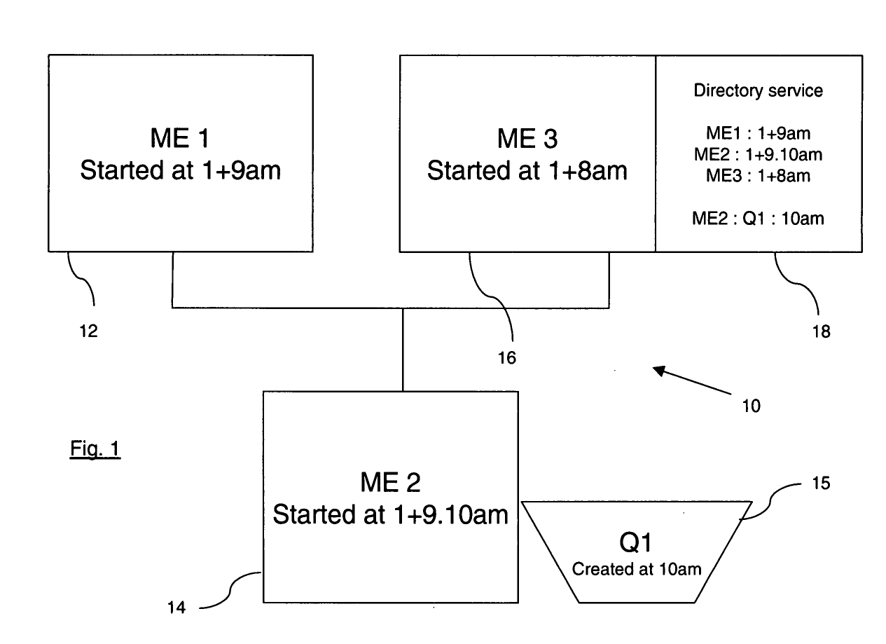

FIG. 1 shows the data processing system 10, which comprises three message processing units 12, 14 and 16 and a directory 18. The message processing units 12 to 16 are messaging engines (MEs) that would typically form a computer system for handling, for example, an Internet website. The directory is responsible for maintaining status information on the message processing units 12 to 16, and communicates with the message processing unit 16.

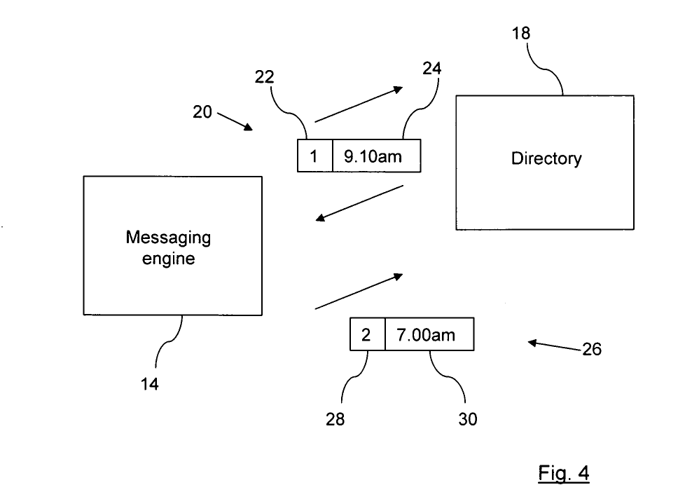

In FIG. 1, the message processing unit 14 is advertising a queue 15 to which the message processing units can put and get messages. Each message processing unit 12 to 16 of the system 10 is arranged to transmit to the directory 18 a first system element identifier 20, which comprises a first component 22 (version indicator) and a second component (sequence indicator) 24 (see FIG. 4). The message processing units 12 to 16 will issue a system element identifier 20 to the directory 18 whenever their status changes. This will typically occur when a message processing unit is started or if it is taken offline by an administrator for updating or for maintenance. Similarly, each of the message processing units 12 to 16 of the system 10 will transmit to the directory 18 a system element identifier for each resource (such as the queue 15) that is to be made available to the message processing units. The directory 18 is effectively maintaining up to date status information on the message processing units 12 to 16, and their resources.

The first component 22 of the system element identifier 20 may be an integer and the second component 24 may be a timestamp read from the internal clock of the message processing unit. The system element identifier 20 will also usually contain further information about the status of the message processing unit that issued the system element identifier 20. The timestamp in the system element identifier 20 allows the directory 18 to order the system element identifiers 20 for each message processing unit. This is needed as other message processing units will refer to the directory 18 for the most recent information about a message processing unit. For example, the message processing unit 12 (which could be for example the front end of a website, receiving orders from customers) may wish to send a message to the message processing unit 14 (which may be handling financial details of customers). The message processing unit 12 will refer to the directory 18 to obtain details of the latest system element identifier for the message processing unit's resource for handling financial details of customers, which will allow the message processing unit 12 to ascertain if the message processing unit's resource is accepting queries/messages of a certain type.

When a message processing unit is started or restarted, it is arranged to receive back from the directory 18 the latest system element identifier 20 that the directory 18 has stored for that particular message processing unit. This is to ensure correct synchronization between the information stored by the directory 18, and the actual status of a message processing unit. The message processing unit will compare the timestamp of the latest system element identifier 20 that is stored by the directory 18, with the time on its own internal clock.

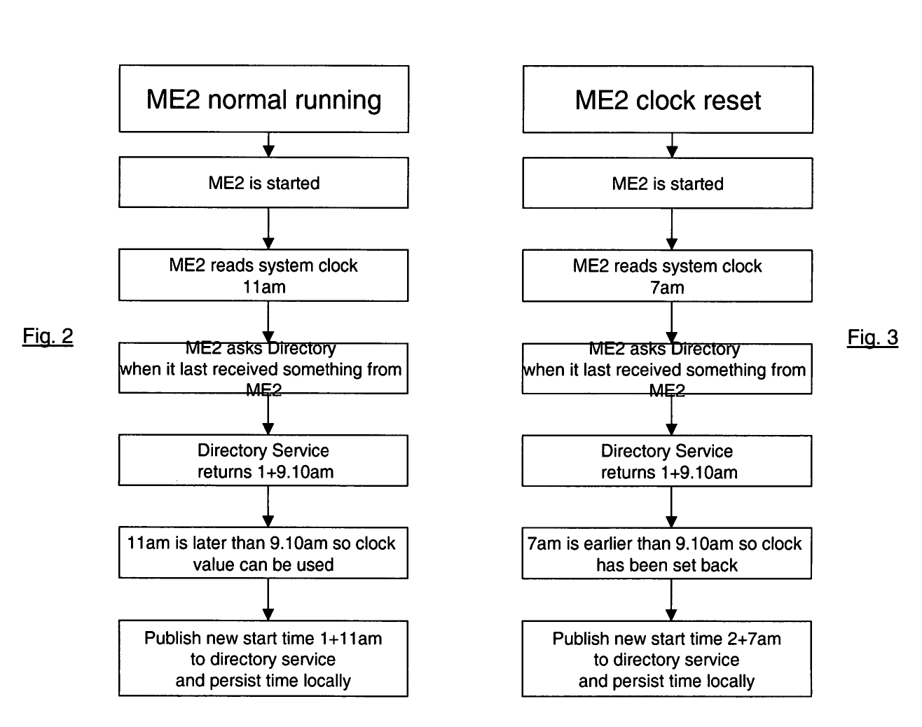

FIGS. 2 and 3 show two alternative possibilities, depending upon the outcome of the comparison between the timestamp of the system element identifier 20 that is last stored by the directory 18, with the time on the internal clock of the message processing unit. In FIG. 2, the message processing unit 14 reads its internal clock as 1 lam, which is later than the timestamp of the system element identifier 20 returned by the directory 18, which is 9.10 am. Since its own internal time is later than that stored by the directory 18 for that message processing unit 14, the message processing unit 14 will transmit a second system element identifier to the directory 18 that will contain the new timestamp of the internal clock, without any amendment to the integer that forms the first component of the system element identifier.

However, FIG. 3 deals with the situation that can arise if the internal clock of the message processing unit 14 has a time that is earlier than that stored by the directory 18 for the message processing unit 14. This will occur if the internal clock has been reset by an administrator, perhaps to test the operation of the system in certain conditions, or this may occur if there has been a technical failure of some kind. When the message processing unit 14 detects that its own internal clock has an earlier time than the timestamp in the system element identifier stored by the directory 18, then it will transmit a second system element identifier 26 (shown in FIG. 4) according to a predefined algorithm.

As can be seen in FIG. 4, the second system element identifier 26 is different from the first system element identifier 20. The first component 28 of the second system element identifier 26 is one greater than the first component 22 of the first system element identifier 20, and the second component 30 of the second system element identifier 26 is an earlier timestamp than the second component 24 of the first system element identifier 20.

By incrementing the first component 28 by one, the directory 18 is able to recognize that the second system element identifier 26 takes precedence over the first system element identifier 20, even though the second system element identifier 26 has an earlier timestamp 30. Any message processing unit in the system that queries the directory 18 about the message processing unit 14, will receive the most recent information about that message processing unit 14, even though there will be system element identifiers with later timestamps. As the message processing unit 14 issues further system element identifiers, they will continue to have the integer “2” as their first component, until the situation arises again that the internal clock of the message processing unit 14 is earlier than the timestamp in the system element identifier returned by the directory 18, in which case the message processing unit 14 will increment the first component to “3”, and issue a new system element identifier accordingly.

This methodology ensures that all resources published by a message processing unit are correctly sequenced by the directory 18, ensuring that all queries to the directory 18 by any message processing unit about a specific message processing unit, will return up to date information. The system will also ensure that the directory 18 does not ignore resources published by any message processing unit, on the basis that the timestamp is earlier than that stored in the latest resource by the directory 18.

Note the present invention has been described in terms of timestamps. It should however be appreciated that this is for explanatory purposes only and that the present invention is not intended to be limited to such. For example another type of sequence number or indeed any type of sequence indicator may be used. Further note that the present invention does not simply relate to the publication of resources but is also applicable, for example, to the deletion of a resource.

When a messaging engine starts it publishes it own existence to the directory. This information is retained by the directory. The information it publishes contains the current timestamp. In the same unit of work as the publication, the messaging engine persists the current timestamp in its persistent store. On restart of the messaging engine, it subscribes for its last publication retained by the directory. It then compares the timestamp in the publication with the timestamp from its persistent store. If the timestamp from the persistent store is an earlier time than the one in the publication, the messaging engine knows that it has been restored from an earlier backup. It can then proceed to resynchronize itself.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is apparent to one skilled in the art that numerous modifications and departures from the specific embodiments described herein may be made without departing from the spirit and scope of the invention.

What is claimed is:

1. A system for operation in a data processing system comprising a plurality of message processing units and a directory communicating with at least one of the message processing units, the system comprising:
a first transmitting component for transmitting to the directory a first system element identifier, the first system element identifier comprising a version indicator and a sequence indicator;
a receiving component for receiving from the directory the first system element identifier;
a second transmitting component for transmitting a second system element identifier, the second system element identifier comprising a version indicator and a sequence indicator, wherein the version for the second system element identifier is determined by a versioning component,
the versioning component operable to compare the sequence indicator in the first system element identifier with an expected sequence indicator to determine what the version indicator for the second system element identifier should be.

2. The system according to claim 1, wherein the version indicator of a system element identifier is an integer, and the sequence indicator is a timestamp.

3. The system according to claim 1, wherein the second system element identifier is different from the first system element identifier.

4. The system according to claim 2, wherein the version indicator of the second system element identifier is one greater than the version indicator of the first system element identifier.

5. The system according to claim 4, wherein the sequence indicator of the second system element identifier is an earlier timestamp than the sequence indicator of the first system element identifier.

6. The system according to claim 1 wherein the versioning component is operable to choose a version indicator different to the version indicator in the first system element identifier inm response to determining that the sequence indicator in the first system element identifier is earlier than the expected sequence indicator such that the version indicates that the second system element identifier takes precedence over the first system element identifier.

7. A method for operation in a data processing system comprising a plurality of message processing units and a directory communicating with at least one of the message processing units, the method comprising:
transmitting to the directory a first system element identifier, the first system element identifier comprising a version indicator and a sequence indicator;
receiving from the directory the first system element identifier; and
transmitting a second system element identifier, the second system element identifier comprising a version indicator and a sequence indicator;
wherein the version for the second system element identifier is determined by a comparing the sequence indicator in the first system element identifier with an expected sequence indicator to determine what the version indicator for the second system element identifier should be.

8. The method according to claim 7, wherein the version indicator is an integer and the sequence indicator is a timestamp.

9. The method according to claim 7, wherein the second system element identifier is different from the first system element identifier.

10. The method according to claim9, wherein the version indicator of the second system element identifier is one greater than the version indicator of the first system element identifier.

11. The method according to claim 10, wherein the sequence indicator of the second system element identifier is an earlier timestamp than the sequence indicator of the first system element identifier.

12. The method according to claim 7 wherein comparing the sequence indicator in the first system element identifier with an expected sequence indicator to determine what the version indicator for the second system element identifier should be is operable to choose a version indicator different to the version indicator in the first system element identifier in response to determining that the sequence indicator in the first system element identifier is earlier than the expected sequence indicator such that the version indicator indicates that the second system element identifier takes precedence over the first system element identifier.

13. A computer program product for operation in a data processing system comprising a plurality of message processing units and a directory communicating with at least one of the message processing units, the computer program product comprising:
a computer usable medium having computer useable program code embodied therein, the computer useable program code comprising:
computer usable program code configured to transmit to the directory a first system element identifier, the first system element identifier comprising a version indicator and a sequence indicator;
computer usable program code configured to receive from the directory the first system element identifier; and
computer usable program code configured to transmit a second system element identifier, the second system element identifier comprising a version indicator and a sequence indicator;
wherein the version for the second system element identifier is determined by computer usable program code configured to compare the sequence indicator in the first system element identifier with an expected sequence indicator to determine what the version indicator for the second system element identifier should be.

14. The computer program product according to claim 13, wherein the version indicator is an integer and the sequence indicator is a timestamp.

15. The computer program product according to claim 13, wherein the second system element identifier is different from the first system element identifier.

16. The computer program product according to claim 15, wherein the version indicator of the second system element identifier is one greater than the version indicator of the first system element identifier.

17. The computer program product according to claim 13, wherein the sequence indicator of the second system element identifier is an earlier timestamp than the sequence indicator of the first system element identifier.

18. The computer program product according to claim 13 wherein the computer usable program code configured to compare the sequence indicator in the first system element identifier with an expected sequence indicator to determine what the version indicator for the second system element identifier should be is operable to choose a version indicator different to the version indicator in the first system element identifier in response to determining that the sequence indicator in the first system element identifier is earlier than the expected sequence indicator such that the version indicator indicates that the second system element identifier takes precedence over the first system element identifier.
